(19) United States
(12) Patent Application Publication
(10) Pub. No.: US 2017/0113425 A1
(43) Pub. Date: Apr. 27, 2017

(54) METHOD FOR REPAIRING AN AIRCRAFT STRUCTURE USING DEFORMABLE SHEETS

(71) Applicant: Airbus Operations SAS, Toulouse (FR)

(72) Inventors: Gilles TARDU, Toulouse (FR); Philippe DUBOIS, LAVAL (FR)

(21) Appl. No.: 15/299,541

(22) Filed: Oct. 21, 2016

(30) Foreign Application Priority Data
Oct. 27, 2015 (FR) 1560267

(51) Int. Cl. B29C 73/10; B32B 37/12; B32B 27/00; B32B 5/06; B32B 7/12; B29C 65/52; B32B 37/18

(52) U.S. Cl. CPC B29C 73/10; B29C 65/52; B32B 37/1292; B32B 37/182; B32B 5/06; B32B 7/12; B32B 27/00; B29K 2105/256

(57) ABSTRACT

A method for repairing an aircraft structure made of composite material which comprises a damaged zone having at least one bend. The method comprises the stacking of at least two sheets of composite material, which each have a thickness allowing manual deformation thereof, a first sheet being applied to the damaged zone and shaped manually so as to follow said at least one bend of the zone, a second sheet being applied to the first sheet and shaped manually so as to follow the shape of the first sheet thus shaped. The use of individual sheets makes it possible to bend them to the desired bend without tools and the resulting stack provides the desired rigidity.

### CROSS-REFERENCES TO RELATED APPLICATIONS

This application claims the benefit of the French patent application No. 1560267 filed on Oct. 27, 2015, the entire disclosures of which are incorporated herein by way of reference.

### FIELD OF THE INVENTION

The invention relates to a method for repairing an aircraft structure made of composite material, a stack of sheets obtained by the method and an aircraft structure comprising such a stack.

### BACKGROUND OF THE INVENTION

Some aircraft have a structure made of composite material such as a carbon fiber composite. The structure may include one or more zones with a single or double bend that are damaged due to various incidents (e.g., denting and possibly piercing of the zone or zones, scratching of the zone or zones, etc.).

Using a piece (sheet metal) of aluminum alloy to repair such a damaged zone is difficult and causes a problem related to incompatibility between the aluminum alloy and the composite material in terms of different thermal expansion coefficients and galvanic corrosion.

There is therefore a need to repair such a damaged zone in a more satisfactory manner than in the prior art discussed above.

### SUMMARY OF THE INVENTION

The present invention therefore relates to a method for repairing an aircraft structure made of composite material which comprises a damaged zone having at least one bend, characterized in that the method comprises the stacking of at least two sheets of at least partially polymerized composite material which each have a thickness allowing manual deformation thereof, a first sheet being applied to the damaged zone and shaped manually so as to follow said at least one bend of the zone, a second sheet being applied to the first sheet and shaped manually so as to follow the shape of the first sheet thus shaped.

By using separate sheets that may or may not be flat (that is to say, with no initial bend) and are at least partially polymerized, and by individually shaping each sheet, it is possible, because the thickness of the sheet is suitable for manual deformation (said thickness being less than the total thickness of the stack of sheets), for the sheet to be shaped (e.g., bent) manually in situ or away from the aircraft and thus be adapted to the bend or bends of the damaged zone. By contrast, in the prior art it was not possible to shape a single piece which had a thickness corresponding to the sum of the thicknesses of the various constituent sheets of said stack.

According to other possible features, taken alone or in combination with one another:
one or more other sheets of composite material, each of which has a thickness allowing it to be deformed manually, are successively applied, one by one, one on top of the other, by shaping each one manually so as to follow the shape of the sheet located below, which has previously been shaped;
the sheets stacked successively one on top of the other each have dimensions (width and length) which are smaller than the dimensions of the sheet located below so as to form a stepped stack of sheets;
each step formed by stacking two sheets in contact one on top of the other has an uncovered peripheral zone of the lower sheet which is not covered by the upper sheet, one or more mechanical fastening members being put in place in this zone to mechanically join the lower sheet, either directly to a sheet located immediately below said lower sheet or directly to one or more edges of the damaged zone located immediately below said lower sheet;
the thickness of each sheet in the stack, which is such that said sheet must be manually deformable, is determined as a function of the orientation of the plies in the composite material and the number thereof;
the sheets of the stack contain plies with orientations corresponding at least to the main orientations of the plies of the composite material of the damaged zone;
the sum of the thicknesses of the various sheets of the stack is at least equal to the thickness of the damaged zone;
the method comprises a step in which temporary fasteners are put in place so as to temporarily fasten the sheets of the stack to one another and to the damaged zone of the aircraft structure during stacking;
the method comprises a step in which permanent fastening members are put in place so as to permanently fasten the sheets of the stack to one another and to the damaged zone of the aircraft structure after stacking;
the composite material of the sheets before stacking is polymerized;
the composite material comprises carbon fibers;
the damaged zone has a single bend or a double bend and each sheet of the stack is shaped manually and individually so as to adopt the single bend or double bend of the damaged zone;
the operation of stacking the sheets is performed directly on the damaged zone or away from the damaged zone (away from the aircraft), for example on a template;
the aircraft structure that includes the damaged zone to be repaired is a primary aircraft structure.

According to another aspect, the invention also relates to a stack of sheets, characterized in that the stack of sheets made up of at least two sheets of composite material that are shaped to match said at least one bend of the damaged zone is obtained by the method described briefly above.

According to yet another aspect, the invention also relates to an aircraft structure made of composite material comprising a damaged zone having at least one bend, characterized in that the aircraft structure comprises, in line with the damaged zone, a stack of sheets as described briefly above.

### BRIEF DESCRIPTION OF THE DRAWINGS

Further features and advantages will become apparent from the following description, given only by way of non-limiting example and with reference to the accompanying drawings, in which:

FIGS. 1a, 1b, 1c are sectional views showing various successive steps of a method according to an embodiment of the invention leading to a stack of sheets according to a first embodiment of the invention;

FIG. 2 is a flow chart showing various successive steps of a method according to an embodiment of the invention;

FIG. 3a is a sectional view showing a stack of sheets according to a second embodiment of the invention, which has been put in place according to the method described with reference to FIGS. 1a-c and 2;

FIG. 3b is a view from above of the stack of sheets shown in FIG. 3a;

FIGS. 3c and 3d are comparative views showing the reduction in secondary bending moments generated in a stack of sheets (FIG. 3d) in comparison to a thick sheet (FIG. 3c);

FIGS. 3e and 3f are comparative views showing the improved shapability of a stack of sheets (FIG. 3f) in comparison to a thick sheet (FIG. 3e);

FIG. 4 is a partial cross-sectional schematic view of a wall of an aircraft structure incorporating a stack of sheets which has been put in place by means of a method according to an embodiment of the invention;

FIGS. 5 and 6 show perspective views of different structural parts of an aircraft with a single and a double bend, respectively, on which damaged zones may be repaired by means of a method according to an embodiment of invention.

### DETAILED DESCRIPTION OF THE PREFERRED EMBODIMENTS

The following description concerns the repair of a damaged zone of an aircraft structure made of composite material, such as a fuselage or a wing of an aircraft.

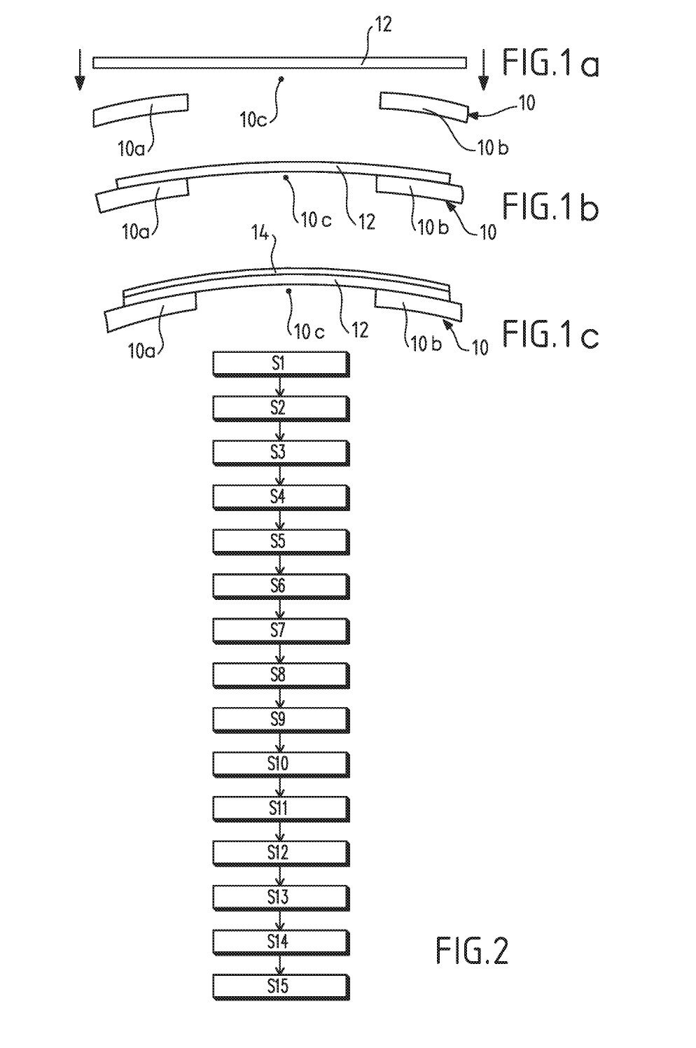

FIGS. 1a-c schematically show, in sectional views, successive steps of a method for repairing a damaged zone 10 of such a structure according to one embodiment of the invention. This method is shown in FIG. 2 in the form of a flow chart comprising several steps.

FIG. 1a shows a damaged zone of the structure which comprises a central opening 10c externally delimited by a peripheral edge. In FIG. 1a, only two opposite parts 10a, 10b of the peripheral edge are visible. The other two adjacent opposite parts of the same edge are not visible in the figure. The zone 10 has been previously cleaned, damaged plies have been removed or a cut has been made in the damaged zone (step S1).

The damaged zone shown has a bend about an axis perpendicular to the plane of the figure and may also have another bend perpendicular to the first bend (double bend). The damaged zone is for example a covering such as an aircraft skin.

The method uses a set of sheets made of composite material which in this example are flat and each have two dimensions (length and width which may be identical) and, perpendicularly thereto, a thickness permitting each sheet to be deformed manually, in particular to be manually bent to follow the bend or bends (in the case of a double bend or a more complex geometry) of the zone to be repaired. A minimum of two sheets is necessary to achieve a stack of sheets to repair the zone with the desired thickness. One sheet with the desired overall thickness to repair the zone would not be sufficiently deformable to follow the desired shape, i.e., the shape of the zone to be repaired. In addition, the stacking of several sheets provides improved transfer of mechanical forces compared to a single thick sheet.

Note that the sum of the thicknesses of the various sheets of the stack is at least equal to the thickness of the damaged zone. Each sheet in the stack is thus considered to be thin relative to the thickness of the damaged zone, that is to say that each sheet has a thickness which is less than the thickness of the damaged zone. The thicker the damaged zone, the more advantageous it is to use a stack of sheets, both in terms of shaping and in terms of transfer of forces.

The sheets are each made of composite material, which in this case is already polymerized. This makes it possible to store the sheets easily and for a long time before they are used without having to worry about them perishing This is particularly useful when it comes to repairing an aircraft structure in an airport as quickly as possible. Indeed, it is important to have available, at the time the aircraft lands (which cannot be predicted in advance), all the elements needed for the repair so as not to cause delays owing to the need to wait for missing parts.

According to one variant, the sheets may be at least partially polymerized, allowing for longer storage while awaiting repair than if they were not cured.

The flatness of the sheets before shaping (no bend before shaping) facilitates storage of the sheets but flatness is however optional. Indeed, the sheets may be bent before being applied to the damaged zone.

The thickness of each sheet (the thickness is not necessarily the same for all sheets in a set) which must be manually deformable is in particular determined as a function of the orientation of the plies in the composite material constituting the sheet and the number of plies. If the sheets are not oriented, they are homogeneous (homogeneous lay-up) and the number of plies is the same in all directions. However, the lay-up may differ from one sheet to another. The plies of the composite material constituting the zone to be repaired usually have one or more orientations or main directions. A main orientation is an orientation in which the greatest number of plies are oriented in the composite material. The orientation of the composite material is chosen depending on the type of forces to be transmitted through the composite material (e.g., orientation at +/−45° to the shearing forces or at 0 or 180° for longitudinal forces, i.e., forces applied in the longitudinal direction of the aircraft). Thus, the plies of the sheets of the stack must have orientations which correspond at least to the orientation or main orientations of the zone to be repaired to allow the maximum transfer of forces along this or these orientations. However, if possible, the sheets of the stack are homogeneous to facilitate storage of the sheets (flat) before stacking.

It should be noted that the thickness of the sheets also depends on the bend or bends of the zone which must be followed.

The method for repairing the zone 10 to be repaired comprises a second step S2 (FIG. 2) in which temporary fastening holes are made in the sheets 12, 14 to be stacked, away from the aircraft, for example on a workbench. Such temporary holes are made for example by drilling, by stacking the sheets one on top of the other in the same way as they will be when they are stacked on the zone to be repaired. In the example shown, the sheets are flat.

In a subsequent step S3, a first sheet 12 which is shaped in the manner described above (FIG. 1a) is positioned above the zone 10. The sheet is bigger than the zone 10 to cover the opening 10c and to cover the peripheral edge or edges 10a, 10b bordering the latter. How much the sheet covers or projects beyond the edges of the zone to be repaired depends on the magnitude of the forces to be transferred. In this step S3, the sheet is applied to the zone 10 and is shaped manually, especially at the edges of said sheet, by exerting manual pressure from above so that it adopts precisely the external bend or bends of the zone 10 so as to obtain the result of FIG. 1b.

In a subsequent step S4, the bent sheet 12 is supported on the edges of the zone 10. Temporary fastening holes are made on the edges of the zone 10 in correspondence with the temporary fastening holes in the sheet 12.

The sheet is removed, the zone is cleaned and adhesive is applied to the edges or parts of the sheet 12 to be supported on the edges of the zone 10. The sheet is then applied to the zone to be repaired by bearing on the edges of the zone 10 (step S5). Temporary mechanical fastening members are then placed in the temporary fastening holes of the sheet and of the zone 10 to hold the sheet mechanically on the zone (step S6). For this step, the temporary mechanical fastening members are for example rivet pins that each ensure alignment between two respective temporary holes in the sheet and zone 10 (peripheral edge(s) of the zone). Alternatively, blind rivets or POP rivets (registered trade mark) made of aluminum may be used for temporary mechanical assembly. Other types of fastening members may alternatively be used.

In step S7, the adhesive is heated, for example using a heating means such as a heating blanket placed over the sheet that is fastened to the zone 10.

After curing of the adhesive (e.g., 2 hours at 60° C.) the heating means used is removed.

In step S8, a second flat sheet 14 is positioned over the zone 10 to be repaired covered with the first sheet 12 (FIG. 1b), in the manner described above for the first sheet 12. This second sheet 14, positioned over the first sheet 12, is then applied to the first sheet 12 of FIG. 1b and manually shaped as explained above (step S3) so as to follow the external bend or bends of the first sheet 12. The sum of the thicknesses of the sheets 12 and 14 must correspond at least to the thickness of the missing part of the zone to be repaired. The thickness of the missing part is obtained from maintenance documents and plans or using tools for determining the thickness of the damaged surface, for example by taking one or more measurements.

Temporary fastening holes are made in the edges of the zone 10 in correspondence with the temporary fastening holes in the sheets 12 and 14 (step S9).

The sheet 14 is removed, the zone is cleaned and adhesive is applied to the sheet 14 to be supported on the sheet 12. The sheet 14 is then again applied to the sheet 12 (step S10). Temporary mechanical fastening members are then placed in the temporary fastening holes of the sheets and of the zone 10 to hold the sheet 14 mechanically on the sheet 12 and the zone 10 (step S11). The same temporary mechanical fastening members as used for step S6 are for example used in this step. Other types of fastening members may alternatively be used.

In step S12, the adhesive is heated, for example using a heating means such as a heating blanket placed over the sheet 14 that is fastened to the zone 10.

After curing of the adhesive, the heating means used is removed, the temporary mechanical fastening members are removed and permanent mechanical fastening members are put in place between the sheets and the zone 10 (step S13). For this step, the permanent mechanical fastening members are for example screw-nut type assembly members with tighter mechanical tolerances than the temporary fastening members. The screw-nut type assembly members for example comply with the HL11 standard and are for example made of titanium. Alternatively, permanent rivets may be used for the permanent mechanical assembly. Other types of fastening members may alternatively be used.

The result of the above steps is shown in FIG. 1c in the form of a stack of two sheets 12, 14 shaped to match the bend or bends of the damaged zone 10 (first embodiment). Note that one or more additional sheets may be stacked successively on top of the sheets 12 and 14 by proceeding in the same way as for the latter.

When the stack has been formed as described above, ECF (Expanded Copper Foil) is placed on the stack to ensure continuity of lightning protection in the skin of the aircraft (step S14). Adhesive is applied and vacuum drying is performed in step S15 (e.g., heating under vacuum in a vacuum bag using a hairdryer type of dryer for 2h30 at 120° C.).

One advantage of a stack of at least two sheets (sheets 12 and 14 and possibly other sheets) is that each sheet is easy to shape individually without using any tools, whereas a sheet of greater thickness would be difficult or even impossible to deform without tools. It is thus possible to repair the damaged zone 10 of the aircraft while it is at an airport, where technical equipment may be limited. For example, in an airport it can be difficult to machine a part for repairs. The method according to the abovementioned embodiment and the variants thereof, and according to the embodiment or embodiments below and the variants thereof is easy to implement in an environment where technical resources are limited.

The stack of sheets thus formed provides the desired mechanical rigidity to the repair zone.

For example, the composite material used for the sheets is made of carbon fibers just like the zone of the aircraft structure to be repaired. However, other composite materials are possible for the sheets even if the composite material of the zone to be repaired is different.

The thickness of each sheet in this example is 1.2 mm.

Moreover, the operation of stacking the sheets on top of one another may alternatively be performed away from the aircraft, for example on a template representative of the zone to be repaired, in particular of the bend or bends thereof The stack thus formed is then conveyed in situ where it is fastened to the zone to be repaired by one of the methods described above.

Note that other embodiments of a method of repair based on the stacking of several composite sheets are conceivable.

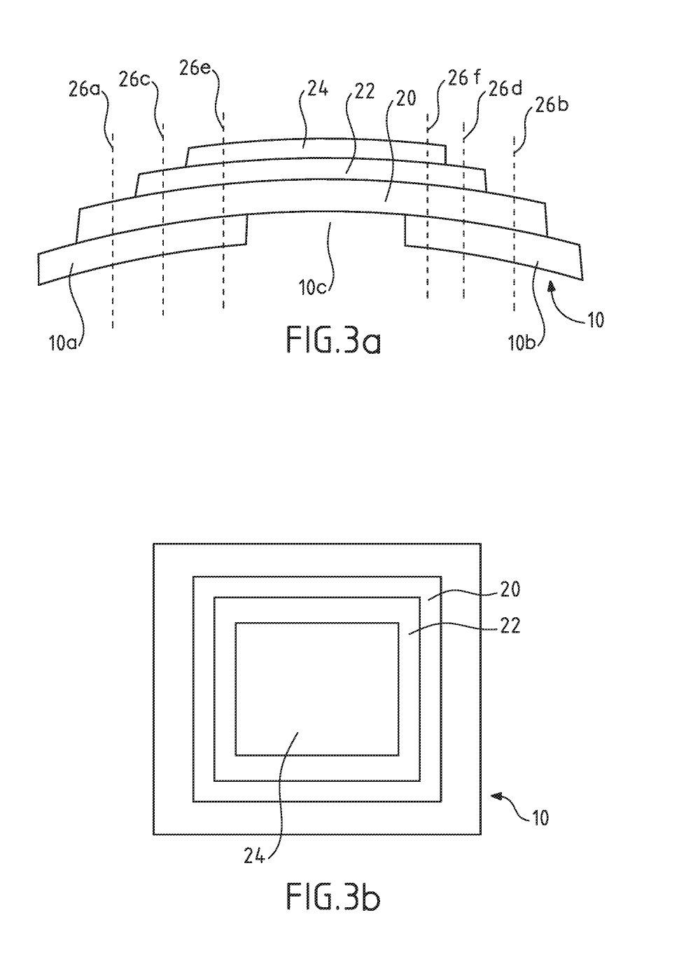

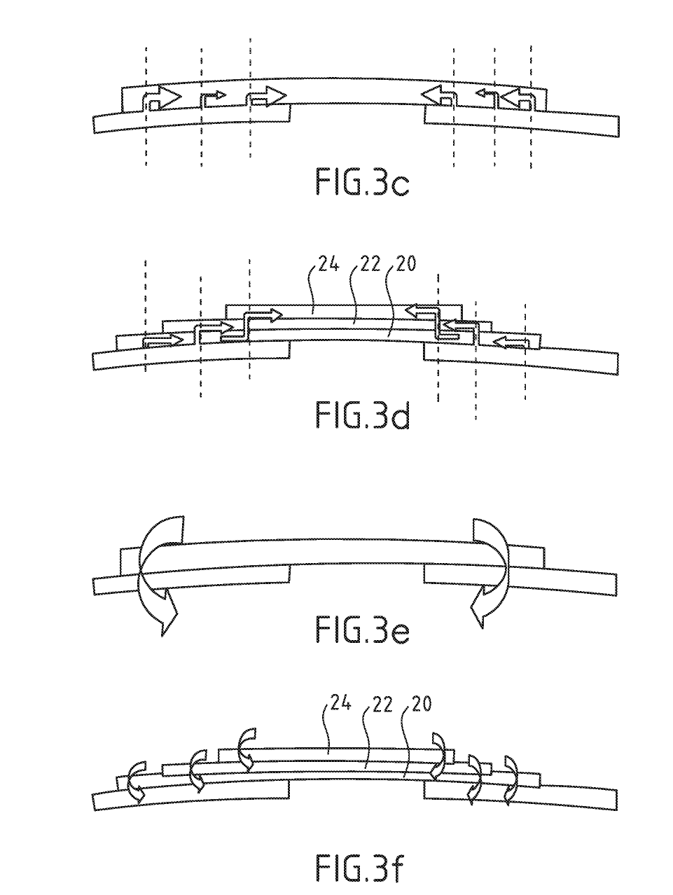

FIG. 3a (second embodiment) shows a stack of flat sheets made of polymerized composite material 20, 22, 24 shaped to match the bend or bends of the damaged zone 10 as explained above. The thickness of each sheet is defined according to the same rules as for the sheets 12 and 14. The thicknesses of the sheets may or may not be identical to each other, as in the first embodiment.

However, the sheets 20, 22, 24 stacked successively one on top of the other do not have the same dimensions (width and length). Indeed, each upper sheet placed on top of a lower sheet is smaller (in terms of width and length) than the lower sheet so as to form a stepped stacked structure or pyramidal structure. Such a pyramidal structure is shown from above in FIG. 3b. As shown, in each step formed by stacking two sheets in contact one on top of the other, each lower sheet has an uncovered peripheral zone which is not covered by the upper sheet. Thus, the sheets 20 and 22 each have a peripheral zone left free which externally borders the upper sheet 22 and 24, respectively. In the example shown, several mechanical fastening members are positioned in each of the zones and they are, for example, distributed over the whole extent of the zone, in particular with a regular arrangement. These fastening members ensure that the assembly/stack is held together mechanically during flight in an integral manner

Mechanical fastening members 26a, 26b, 26c, 26d, 26e, 26f thus assemble together mechanically, along the fastening lines (the members are inserted into fastening holes previously made during implementation of the repair method and, in particular, when the stack of sheets is formed), and respectively, the first sheet 20 with the edges 10a, 10b of the damaged zone 10 located immediately below, the second sheet 22 with the first sheet 20 located immediately below and with the edges 10a, 10b of the zone 10 located below the first sheet 20, the third sheet 24 with the second sheet 22 located immediately below, the first sheet 20 located under the second sheet and the edges 10a, 10b of the zone 10 located below the first sheet 20. These mechanical fastening members are permanent members as described above. However, during implementation of the repair method and, in particular, during the formation of the stack of sheets, temporary mechanical fastening members are first put in place in the fastening holes, then removed before the permanent members are put in place. Note that the number of fastening members depends in particular on the extent of the peripheral zone of each sheet to be assembled and on the mechanical stresses to which the sheets will be subjected when the aircraft is put into service (in flight).

The fastening members are generally spaced apart from one other according to the following rule: two consecutive fastening members positioned in each peripheral zone of the sheets 20 and 22 left free, which externally borders the upper sheet (22 and 24, respectively), are spaced apart by a distance of between 4 and 6 times the diameter of the fastening members.

Similarly, the distance between each of the fastening members and the edge of the upper sheet (in this example the sheets 22 and 24, respectively) is at least twice the diameter of the fastening members to prevent problems in terms of caulking when the aircraft is put into service and in terms of deformation of the assembly/stack of sheets.

These rules apply regardless of the number sheets in the stack.

Three sheets have been shown by way of example but a stack of two sheets may also be envisaged as required.

One advantage of a stack of at least two sheets with a stepped structure is that such a stack is less prone to secondary bending when the aircraft is in service since the movement of the neutral fibers of each sheet is less than the movement of the neutral fibers of a thicker sheet. Thus, the mechanical fastening members 26a, 26b, 26c, 26d, 26e, 26f of FIG. 3a which mechanically hold the structure together in the zone repaired are less mechanically stressed in bending than with a stack of sheets having the same dimensions.

This is illustrated by FIGS. 3c and 3d, which are comparative schematic views of a thick sheet (FIG. 3c) and the stack of sheets of smaller thickness of FIG. 3a (FIG. 3d). The arrows show the secondary bending moments passing through the neutral fibers and the thickness of the arrows reflects the intensity of the secondary bending moment.

The stack of sheets is therefore mechanically more robust with improved loading.

The fact that the secondary bending applied to the mechanical fastening members is reduced is particularly useful when the stepped structure (staggered structure) of the stack is preferably used to repair zones of primary aircraft structures. A primary aircraft structure is a structure of the aircraft through which large mechanical forces pass and where the various mechanical assemblies, including fastening members, are therefore highly stressed. For this type of structure, permanent assembly by adhesive bonding is not feasible.

This type of structure is for example the primary structure of the fuselage of the aircraft comprising the fuselage frames, the keel beam.

In contrast to primary structures, there are also secondary structures such as the ‘belly fairing.’ Such structures are subjected to lower mechanical stress in terms of the transmission of forces and the parts to be assembled may be assembled simply by adhesive bonding, this being sufficient to transfer the forces.

Generally, a primary structure is attached to the aircraft and if it is damaged or if a part of this structure is lost during flight it can compromise piloting of the aircraft. For example, in the event of loss of a fuselage panel, depressurization problems can occur and cause damage to the aircraft.

Therefore, to repair zones of primary aircraft structures, use is made of a stepped structure of composite sheets stacked one on top of the other with mechanical fastening members or elements in the uncovered zones of the sheets (peripheral zones externally bordering the upper sheets) in order to mechanically join the sheets to one another and also to the zone to be repaired. This thus ensures that the stacked structure is held together mechanically in an integral manner

Such a stack also has the same advantages as described with reference to the first embodiment of FIG. 1c in terms of deformability, ease of fitting, etc.

FIGS. 3e and 3f are comparative schematic views comparing a thick sheet (FIG. 3e) and the stack of sheets of smaller thickness of FIG. 3a (FIG. 3f). This comparison shows the greatest mechanical force that has to be applied to a thick sheet to deform it compared to the forces that need to be applied to deform each sheet of smaller thickness of the stack.

Such a stack requires no machining, so that airlines do not need special manufacturing units in airports, where these repairs have to be done. Moreover, machining is expensive.

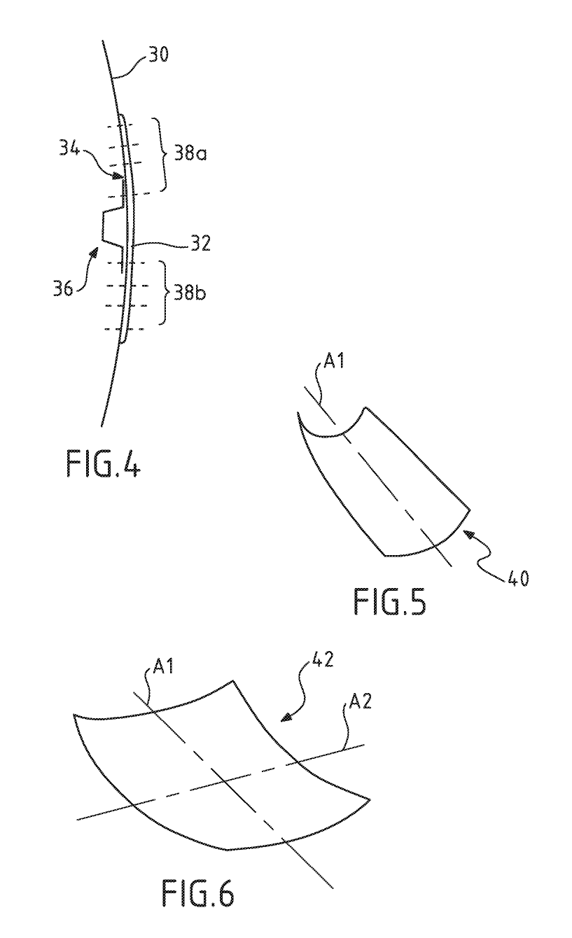

FIG. 4 shows in cross section a portion of a wall (fuselage) of an aircraft structure. A stack 32 of sheets according to one of the previous embodiments (or with a different number of sheets, the same or different thicknesses, the same or different material, etc.) has been applied to a zone 34 to be repaired. The zone has a stringer 36 on the inside face of the wall. The wall may have suffered various types of damage, e.g., the skin of the aircraft and/or the stringer may have been damaged. The stringer may thus be replaced or repaired. In the example shown, the zone 34 of the skin has been repaired in order to withstand the mechanical forces that pass through the stringer 36.

Two sets of fastening members 38a, 38b have been used for example to fasten, along fastening lines, the stack/assembly 32 to the zone, and in some cases, to the stringer.

FIGS. 5 and 6 are perspective views of the inside of different parts of aircraft structures to which the method according to the embodiments described above may be applied. These structure portions have, in the case of one 40, a single bend about a longitudinal axis A1 (such a bend is found for example in the cylindrical central zone of an aircraft), and in the case of the other 42, a double bend about both a longitudinal axis A1 and a transverse axis A2 (such a bend is found for example at the front and rear ends of an aircraft).

Note that the structures to be repaired according to the method described above may be quite varied. Thus, repairs may involve frames, beams, etc.

The method described above, which makes it possible to obtain in particular the stacks of sheets of FIGS. 1c and 3, may be implemented without undue difficulty in the field, using simple means, by moderately skilled operators, in a relatively short time.

Furthermore, the use of sheets of composite material to repair an aircraft structure made of composite material does not lead to problems in terms of galvanic corrosion or differential thermal expansion.

The repair method used does not adversely affect the zone around the zone to be repaired.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for repairing an aircraft structure made of composite material which comprises a damaged zone having at least one bend, comprising the steps:
stacking at least two sheets of at least partially polymerized composite material which each have a thickness allowing manual deformation thereof,
applying a first of the at least two sheets to the damaged zone,
shaping the applied first sheet manually so as to follow said at least one bend of the zone,
applying at least one second sheet to the first sheet, and
shaping the at least one second sheet manually so as to follow the shape of the shaped first sheet.

2. The method according to claim 1, wherein one or more additional sheets of composite material, each of which has a thickness allowing it to be deformed manually, are successively applied, one by one, one on top of the previous sheet, by shaping each one manually so as to follow the shape of the sheet located below, which has previously been shaped.

3. The method according to claim 1, wherein the at least one second sheet stacked on top of the first sheet has width and length dimensions which are smaller than width and length dimensions of the first sheet located below, so as to form a stepped stack of sheets.

4. The method according to claim 2, wherein the second sheet and the one or more additional sheets stacked successively one on top of the previous sheet each have length and width dimensions which are smaller than length and width dimensions of the sheet located below, so as to form a stepped stack of sheets.

5. The method according to claim 4, wherein each step formed by stacking two sheets in contact one on top of the other leaves an uncovered peripheral zone of the lower sheet which is not covered by the upper sheet, and including the step of putting one or more mechanical fastening members in place in this zone to mechanically join the lower sheet, either directly to a sheet located immediately below said lower sheet or directly to one or more edges of the damaged zone located immediately below said lower sheet.

6. The method according to claim 1, wherein a thickness of each sheet in the stack is such that said sheet may be manually deformable, is determined as a function of an orientation of fiber plies in the composite material and a number of such plies.

7. The method according to claim 1, wherein the sheets of the stack contain fiber plies with orientations corresponding at least to main orientations of fiber plies of the composite material of the damaged zone.

8. The method according to claim 1, wherein a sum of thicknesses of the various sheets of the stack is at least equal to a thickness of the damaged zone.

9. The method according to claim 1, further comprising a step in which temporary fasteners are put in place so as to temporarily fasten the sheets of the stack to one another and to the damaged zone of the aircraft structure during the step of stacking.

10. The method according to claim 9, further comprising a step in which permanent fastening members are put in place so as to permanently fasten the sheets of the stack to one another and to the damaged zone of the aircraft structure after stacking.

11. The method according to claim 1, wherein the composite material of the sheets is polymerized before the step of stacking.

12. The method according to claim 1, wherein the damaged zone has a single bend or a double bend and each sheet of the stack is shaped manually and individually so as to adopt the single bend or double bend of the damaged zone.

13. The method according to claim 1, wherein the operation of stacking the sheets is performed directly on the damaged zone or away from the damaged zone.

14. The method according to claim 1, wherein the aircraft structure that includes the damaged zone to be repaired is a primary aircraft structure.

15. A stack of sheets configured to be applied to a damaged zone of an aircraft structure, the damaged zone having at least one bend, the stack of sheets comprising at least two sheets of composite material that each have a thickness allowing manual deformation thereof, and which are each manually shaped to match said at least one bend of the damaged zone.

16. An aircraft structure made of composite material comprising a damaged zone having at least one bend, wherein the aircraft structure comprises, in line with the damaged zone, a stack of sheets comprising at least two sheets of composite material that each have a thickness allowing manual deformation thereof, and which are each manually shaped to match said at least one bend of the damaged zone.
